(19) United States
(12) Patent Application Publication
(10) Pub. No.: US 2003/0110096 A1
(43) Pub. Date: Jun. 12, 2003

(54) Method, system, and apparatus for executing open services

(76) Inventor: Naiem Dathi, San Francisco, CA (US)

Correspondence Address: HEWLETT-PACKARD COMPANY, Intellectual Property Adminstration, P. O. Box 272400, Fort Collins, CO, 80527-2400, US

(21) Appl. No.: 10/349,303

(22) Filed: Jan. 21, 2003

Related U.S. Application Data
(63) Continuation of application No. 09/430,352, filed on Oct. 28, 1999.

(51) Int. Cl. G06F 17/60

(52) U.S. Cl. 705/26

(57) ABSTRACT

A method, system, and apparatus for enabling exchange of an open service for value in an electronic commerce system. The present embodiment creates an open service description and an open service contract view application programming interface (API) that enable operation of an open service instance in an electronic commerce system. The open service contract view enables message passing between open service instances by mapping programming language code to an open service instance. That is, the present embodiment includes an interface to convert code, such as object-based technology or linguistic communication technology, such as agent software, or code written to comply with an Interface Definition Language (IDL), into an open service instance. The present embodiment also includes information that enables charging and billing associated with performance of the open service.

### RELATED APPLICATION

The following application is related to the present application. U.S. Patent Application entitled “METHOD, SYSTEM AND APPARATUS FOR OPEN SERVICES ARCHITECTURE,” attorney docket number 10992404-1, naming as inventor Naiem Dathi, assigned to the assignee of the present invention and filed concurrently herewith, the detailed description and figures of which are incorporated by reference in their entirety as specified in the specification of the present invention.

### FIELD of the INVENTION

The present invention relates generally to a method, system, and apparatus for executing an open service contract in an electronic commerce environment.

### BACKGROUND of the INVENTION

Transacting business, such as exchanging value for service, in an electronic computer-based environment, such as the internet, imposes new constraints on existing computer-based programs. Computer code development is difficult and ensuring that code accurately operates requires a great deal of effort. Therefore, re-using existing code is advantageous. Existing computer programming paradigms, such as the client-server computing model, may change to take advantage of changes in electronic computer-based environments, such as the internet. Therefore, it would be useful for enabling electronic business transactions to create computer-based code that adapts existing code when programming paradigms change.

### SUMMARY of the INVENTION

The present embodiment is a method, system, and apparatus for creating an open service description and an open service contract view application programming interface (API) that enable operation of an open service instance in an electronic commerce system. The present embodiment includes an open service execution module that includes an interface to convert code, such as object-based technology or linguistic communication technology such as agent software, or code written to comply with an Interface Definition Language (IDL), into an open service instance. The present embodiment novelly migrates computer-based code that complies with programming paradigms to an open service instance. For example, the open service execution module migrates an open service element that is compatible with an IDL, an object-oriented software component technology, or a linguistic communication technology, such as agents, to an open service instance. A programming paradigm is typically embodied in a computer-based language that is used to code a computer system.

The present embodiment enables exchange of an open service for value in an electronic commerce system. An open service is a service freely offered in a computer-based electronic environment by a buyer or a seller. An open service provides functionality in exchange for value and the use of the service can be billed flexibly, on a per use basis. More particularly, an open service may be offered with a description of the service functionality and a range of management policies.

Management policies may include information about charging and pricing associated with performance of the open service. In the present embodiment both the open service offer and an executable open service instance are managed by the open service execution module during the open service lifecycle. The open service lifecycle includes the phases of open service offer creation, open service offer advertising and discovery, pre-contractual negotiation, open service contract formation, and open service contract performance.

The open service offer is managed by the open service execution module to create an open service contract. There may be a collection of open service offers' related to an open service contract. The open service contract also includes terms and conditions of performance of the open service contract that include billing and payment policies. Additionally the open service contract may include the penalty policies for breach of the open service contract.

The present embodiment includes an open service contract view API that enables message passing between open service instances by mapping programming language code to an open service instance and enabling billing of the open service.

Other aspects and advantages of the present invention will become apparent from the following detailed description, taken in conjunction with the accompanying drawings, illustrating by way of example the principles of the invention.

### BRIEF DESCRIPTION of the DRAWINGS

The accompanying drawings are incorporated in and constitute a part of this specification and, together with the description, explain the advantages and principles of the invention. In the drawings,

FIG. 1A is a block diagram that illustrates an open service execution module that operates in a computer system;

FIG. 1B is a block diagram that illustrates a compiler technology that operates in cooperation with the open service execution module;

FIG. 1C is a block diagram that illustrates the operation of the open service execution module in coordination with an emulator;

FIG. 2 illustrates data structures and modules used by the open service execution module that may be stored in the memory;

FIG. 3A is a block diagram that illustrates the open service execution module;

FIG. 3B is a flow diagram that illustrates the operation of the open service creation module and the open service provisioner module;

FIG. 3C is a state diagram that illustrates the state of information and data during the operation of the open service execution module;

FIG. 4 is a block diagram that illustrates the operation of executing an open service instance;

FIG. 5A is a block diagram that illustrates the billing operation;

FIG. 5B is a flow diagram that illustrates the billing of events;

FIG. 6A is a block diagram that illustrates the elements of an interaction;

FIG. 6B is a block diagram that shows the operation of a conversation and a programming paradigm;

FIG. 7A is a flow diagram that illustrates the transmission of information associated with open service instances during the execution of open service instances; and

FIG. 7B is a flow diagram that illustrates the operation of forming and performing an open service contract.

### DETAILED DESCRIPTION

In the following detailed description and in the several figures of the drawings, like elements are identified with like reference numerals.

Broadly stated, the present embodiment includes an open service execution module that creates an open service description and an open service contract view API that enable operation of an open service instance in an electronic commerce system. The open service instance is computer-based code that executes on a computer system and performs an open service. The open service execution module manages an open service offer and the performance of an open service contract during execution of the open service instance. An electronic commerce system enables computer-based messages to be transmitted, typically over a computer network, such as the internet. Further, the electronic commerce system enables business transactions, such as the exchange of open services for value, in a computer-based environment.

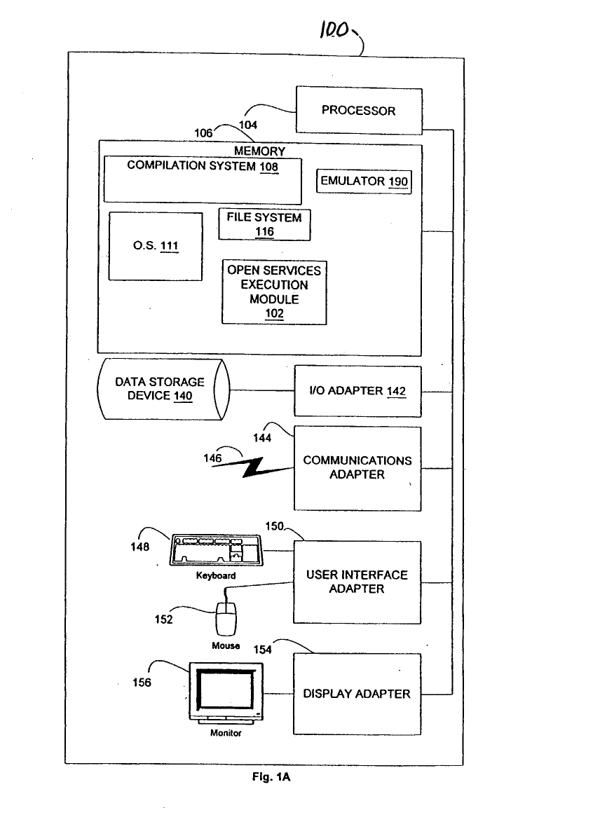

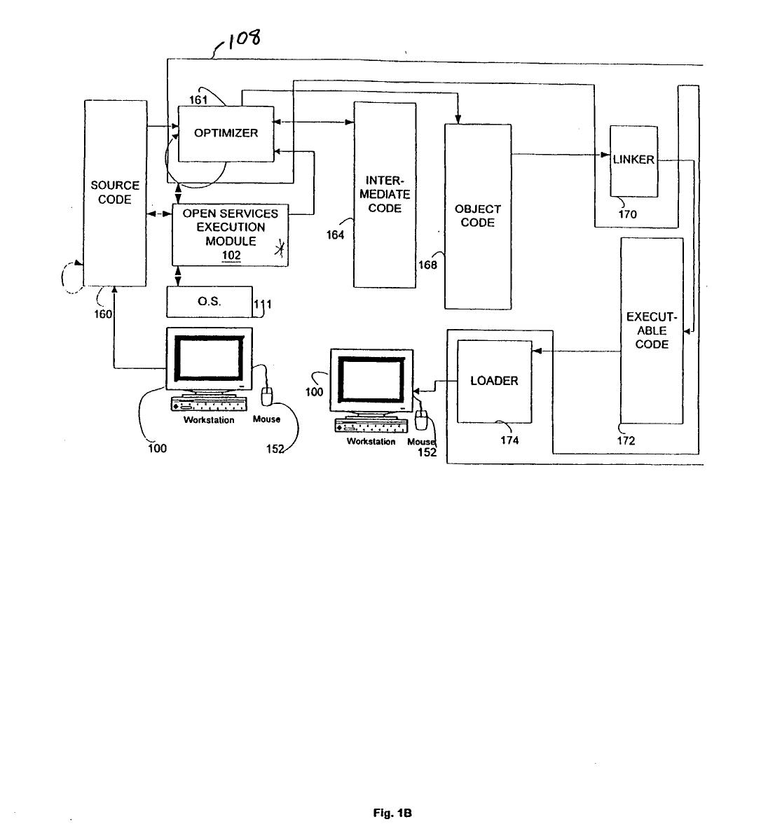

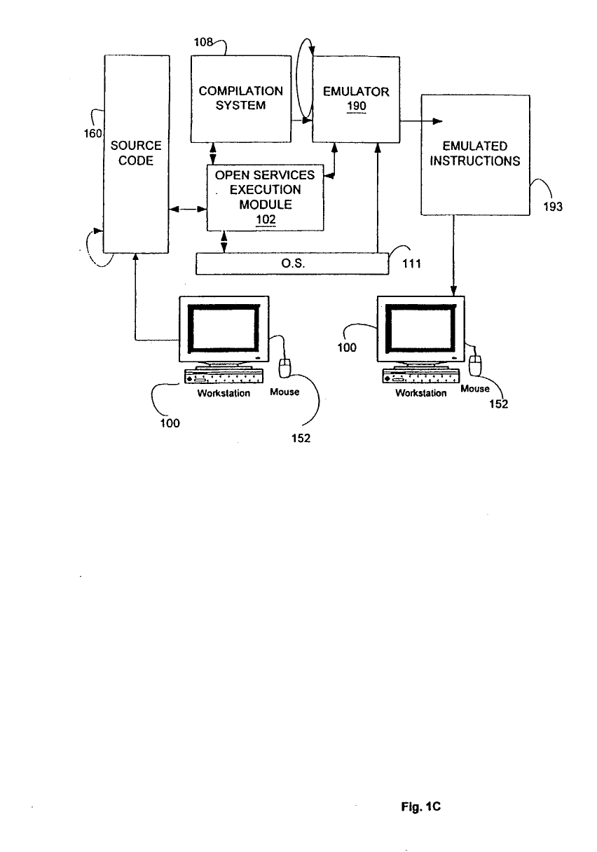

FIG. 1A further represents the computer system 100 that includes components such as a processor 104, the memory 106, a data storage device 140, an input/output (I/O) adapter 142, a communications adapter 144, a communications network 146, a user interface adapter 150, a keyboard 148, a mouse 152, a display adapter 154, and a computer monitor 156. It will be understood by those skilled in the relevant art that there are many possible configurations of the components of the computer system 100 and that some components that may typically be included in the computer system 100 are not shown. The electronic commerce system may be embodied in the computer system 100.

It will be understood by those skilled in the art that the functions ascribed to the open service execution module 102, or any of its functional files, typically are performed by a central processing unit that is embodied in FIG. 1A as the processor 104 executing such software instructions 208.

The processor 104 typically operates in cooperation with software programs such as the compilation system 108, the operating system (O.S.) 111, and the open service execution module 102. Henceforth, the fact of such cooperation among the processor 104 and the open service execution module 102, whether implemented in software, hardware, firmware, or any combination thereof, may therefore not be repeated or further described, but will be implied. The open service execution module 102 typically operates in cooperation with the emulator 109 and the compilation system 108 but is not limited to such operation. For example the open services module 102 may operate in cooperation with the O.S. 111.

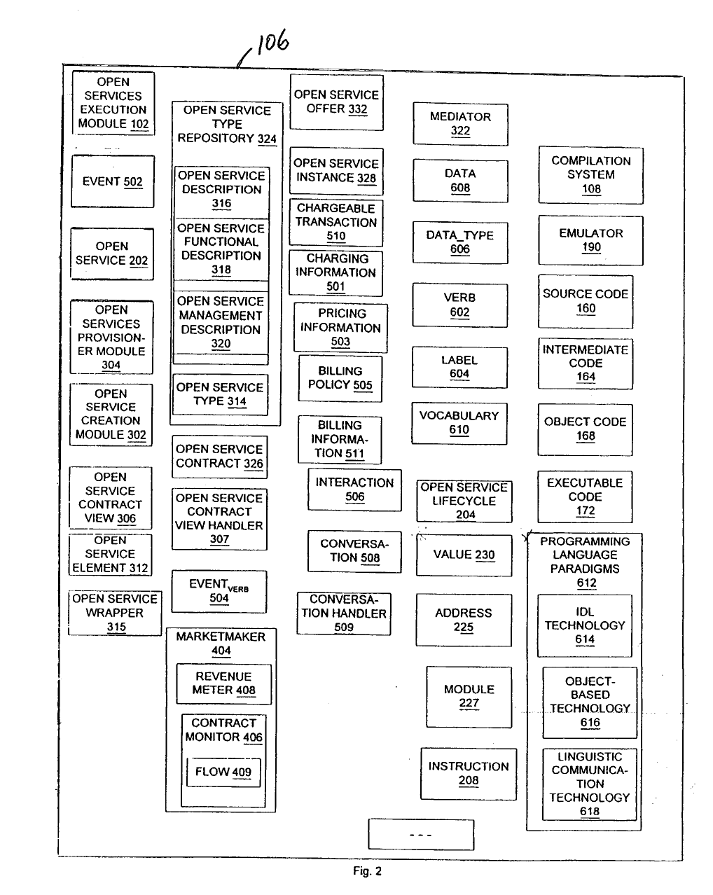

The O.S. 111 may cooperate with a file system 116 that manages the storage and access to files within the computer system 100. Files typically include instructions 208 and data 608 (as shown in FIG. 2). The interaction between the file system 116 and the O.S. 111 will be appreciated by those skilled in the art.

It will also be understood by those skilled in the relevant art that the functions ascribed to the open service execution module 102 and its functional files, whether implemented in software, hardware, firmware, or any combination thereof, may in some embodiments be included in the functions of the O.S. 111. That is, the O.S. 111 may include files from the open service execution module 102. In such embodiments, the functions ascribed to the open service execution module 102 typically are performed by the processor 104 executing such software instructions 208 in cooperation with aspects of the O.S. 111 that incorporate the open service execution module 102. Therefore, in such embodiments, cooperation by the open service execution module 102 with aspects of the O.S. 111 will not be stated, but will be understood to be implied.

The open service execution module 102 may be embodied in any computer-readable medium for use by or in connection with an instruction execution system, apparatus, or device, such as a computer system 100 or other system that can fetch the instructions 208 (as shown in FIG. 2). In the context of this document, a “computer-readable medium” can be any medium that can contain, store, communicate, propagate, or transport the program for use by or in connection with the instruction execution system, apparatus, or device. The computer-readable medium can be, for example but is not limited to, an electronic, magnetic, optical, electromagnetic, infrared, or semiconductor system, apparatus, device, propagation medium, or computer memory 106.

Computer memory 106 may be any of a variety of known memory storage devices or future memory devices, including any commonly available random access memory (RAM), cache memory, magnetic medium such as a resident hard disk, or other memory storage devices. In one embodiment the O.S. 111 and the open service execution module 102 may reside in the memory 106 during execution in the computer system 100. The term “storage” refers herein to computer resources such as the memory 106, and may be used to store data 608 or instructions 208 used in executing a computer program.

The compilation system 108 and the O.S. 111 may also reside in the memory 106 when the open service execution module 102 is operating. Further, the compilation system 108 may operate in cooperation with the O.S. 111 to execute the open service execution module 102. That is, the present embodiment may employ the compilation system 108 to resolve any system-specific information such as address 225 locations that are necessary to execute the open service execution module 102 in the computer system 100.

The open service execution module 102 includes instructions 208 and data 608 that may be referred to as “values” 230 (as shown in FIG. 2) such as integer, real, or complex numbers; or characters. Alternatively, the values 230 may be pointers that reference values 230. Therefore, a pointer provides direction to locate a referenced value 230. For instance, an instruction 208 may represent a computer address 225 (as shown in FIG. 2) that may be a computer hardware register or a location in the memory 106. Instructions 208 may also include variables that are identifiers for values 230. That is, the variables may provide storage for values 230. The reference element value 230 is distinguished from the term “value” when used herein to express worth of an open service 202 (as shown in FIG. 2).

It will be appreciated that the term “execute” refers to the process of manipulating code, such as software or firmware instructions 208, for operation on the computer system 100. The term “code” refers to instructions 208 or data 608 used by the computer system 100 for the purpose of generating instructions 208 or data 608 that execute in the computer system 100. Also, the term “module” 227 (as shown in FIG. 2) may refer to a software “procedure” or “function” such as a unit of code that may be independently compiled. A “program” contains software program code, may contain at least one module 227, and may be independently compiled and executed.

It will be appreciated that an emulator 190 may be included in the computer system 100. The emulator 190 substitutes instructions 208 typically associated with a different computer system 100 than the executing computer system 100, for the original instructions 208. It will be appreciated that the substituted instructions 208 may be associated with a hardware, software, or firmware representation of a different computer system 100. The cooperation of the open service execution module 102 and the emulator 190 is discussed with reference to FIG. 1C.

The open service execution module 102 may be implemented in the programming language marketed under the trademark JAVA,™ although it will be understood by those skilled in the relevant art that other programming languages could be used. Also, the open service execution module 102 may be implemented in any combination of software, hardware, or firmware.

The data storage device 140 may be any of a variety of known or future devices, including a compact disk drive, a tape drive, a removable hard disk drive, or a diskette drive. Any such program storage device may communicate with the I/O adapter 142, that in turn communicates with other components in the computer system 100, to retrieve and store data 608 used by the computer system 100. As will be appreciated, such program storage devices typically include a computer usable storage medium having stored therein a computer software program and data 608.

Input devices could include any of a variety of known I/O devices for accepting information from a user, whether a human or a machine, whether local or remote. Such devices include, for example a keyboard 148, a mouse 152, a touch-screen display, a touch pad, a microphone with a voice recognition device, a network card, or a modem. The input devices may communicate with a user interface I/O adapter 142 that in turn communicates with components in the computer system 100 to process I/O commands. Output devices could include any of a variety of known I/O devices for presenting information to a user, whether a human or a machine, whether local or remote. Such devices include, for example, the computer monitor 156, a printer, an audio speaker with a voice synthesis device, a network card, or a modem. Output devices such as the monitor 156 may communicate with the components in the computer system 100 through the display adapter 154. Input/output devices could also include any of a variety of known data storage devices 140 including a compact disk drive, a tape drive, a removable hard disk drive, or a diskette drive.

By way of illustration, program code may typically be loaded through an input device and may be stored on the data storage device 140. A copy of the code or portions of it, may alternatively be placed by the processor 104 into the memory 106 for execution on the computer system 100.

The computer system 100 may communicate with the network 146 through a communications adapter 144, such as a networking card. The network 146 may be a local area network, a wide area network, or another known computer network or future computer network. It will be appreciated that the I/O device used by the open service execution module 102 may be connected to the network 146 through the communications adapter 146 and therefore may not be co-located with the computer system 100. It will be further appreciated that other portions of the computer system 100, such as the data storage device 140 and the monitor 156, may be connected to the network 146 through the communications adapter 144 and may not be co-located.

The open service execution module 102 enables electronic commerce transactions over a computer-based network 146, such as the internet. The open service execution module 102 novelly associates functional description information about the open service instance 328 and billing information 511 (as are shown in FIG. 2) about the open service instance 328 to enable electronic commerce transactions to occur without dependence on client-service computer configurations.

FIG. 1B is a block diagram that illustrates a compiler technology 108 that operates in cooperation with the open service execution module 102. The open service execution module 102 may use software source code 160 that is generated from input computer system 100 I/O devices such as a keyboard 148 (as shown in FIG. 1A) and a mouse 152. The present embodiment may operate in cooperation with the O.S. 111 and the compilation system 108 thereby enabling execution of an open service instance 328 (as shown in FIG. 2). It will be appreciated that the present embodiment operates on any multi-purpose computer system 100 and is not limited to the illustration herein. A software developer may create source code 160 typically in a high-level programming language such as “C” or the product marketed under the trademark JAVA.™

Alternatively, the open service execution module 102 may operate in cooperation with a programming paradigm, such as an IDL 614 (as shown in FIG. 2). An example of an IDL 614 is CORBA. An IDL 614 typically defines an interface that is used with source code 160 that complies with the IDL 614. Therefore, the source code 160 may be developed to comply with an IDL 614 and is then translated to a form of source code 160 that operates with the compilation system 108. The open service execution module 102 may operate in cooperation with any computer-based source code 160, such as code that complies with an IDL 614 to flexibly form and manage an open service contract 326.

The computer system 100 may manage the processing of the source code 160 through the O.S. 111. The O.S. 111 may direct the processing of the source code 160 by a compiler optimizer 161 that may generate intermediate code 164 from the source code 160. The intermediate code 164 typically is a list of intermediate-level language instructions 208. Alternatively, the optimizer 161 may generate object code 168 that includes optimization changes that may be dependent on the particular multi-purpose computer system 100 on which the compiler optimizer technology operates.

In the present embodiment the linker 170 may operate on the output of the optimizer 161 which may be object code 168. In order to execute the object code 168 it is combined with one or more object code modules 227 to create combined user process executable code 172 by a process known as linking.

The present embodiment may employ a linker 170 to resolve any undefined computer location references in the object code 168 and to generate executable code 172 capable of executing on an output multi-purpose computer system 100 with I/O devices such as a keyboard 148 and a mouse 152. It will be appreciated that the input computer system 100 and the output computer system 100 may be the same computer system 100 and are not limited to the configuration illustrated.

The open service instance 328 is a form of executable code 172 that executes on a computer system 100 to perform an open service 202 (as shown in FIG. 2). In the present embodiment the executable code 172 may be formatted to enable a loader 174 to load the executable code 172 into the computer system 100 for execution. The executable code 172 may be any of a variety of known executable files or an executable file of a type to be developed in the future. Examples of such known files are those having an extension of “.exe” operating under a DOS or Windows operating system or an “a.out” file of an O.S. 111 marketed under the trademark UNIX®. It will be appreciated that typically the compilation system 108 may include the optimizer 161, the linker 170, and the loader 174. The optimizer 161 or any other functional component of the compilation system 108 may cooperate with the open services execution module 102 thereby enabling flexible formation and management of an open service contract 326 (as shown in FIG. 2).

FIG. 1C is a block diagram that illustrates the operation of the open services execution module 102 that operates in coordination with the emulator 190, such as the product marketed under the trademark JAVA Virtual Machine.™ Source code 160 typically is loaded through an input device and may be stored on the data storage device 140 (as shown in FIG. 1A). A copy of the source code 160 or portions of it, may alternatively be placed by the processor 104 into the memory 106 (as are shown in FIG. 1A) for execution on the computer system 100. The 0.S. 111 may operate to associate the source code 160 with the compilation system 108 that may generate code for use by the emulator 190. The open service execution module 102 may also operate with the compilation system 108 and the O.S. 111 to create an open service instance 328 (as shown in FIG. 2). The compilation system 108 may generate code for use by the emulator 190.

Alternatively, the open service execution module 102 may operate in cooperation with code that complies with a programming paradigm 612, such as an IDL 614 (as are shown in FIG. 2). Therefore, the source code 160 representing the open service 202 (as shown in FIG. 2) may be developed to comply with an IDL 614 that is then translated to a form of source code 160 that operates with the compilation system 108 and the emulator 109.

In yet another alternative the open service execution module 102 may operate with the emulator 190 directly thereby creating an open service instance 328. The emulator 190 may then operate, typically in an iterative manner, to create emulated instructions 193. Typically the emulated instructions 193 are associated with a different computer system 100 than the executing computer system 100.

FIG. 2 illustrates data structures 608 and modules 227 used by the open service execution module 102 that may be stored in the memory 106. Further, FIG. 2 represents memory-based computer structures that may be embodied in the memory 106 during the execution of the open service execution module 102. The memory 106 may include the following:

an event, or message 502 that contains information, typically data 608, and communicates the contained information in a computer system 100 (as shown in FIG. 1A);

an open service 202 that is a service freely offered in a computer-based electronic environment;

an open service execution module 102 that creates an open service description 318 and an open service contract view 306 that enable operation of an open service instance 328 in an electronic commerce system;

an open service creation module 302 that creates an open service description 318 and an open service type 314 by use of an open service element 312;

an open service provisioner module 304 that operates to associate at least one open service description 318 with an open service type 314;

an open service contract view 306 that enables conversion of a conversation 508, that is created by the execution of an open service instance 328, to a format that complies with a programming language paradigm 612;

an open service element 312 that includes computer-readable directives to provide a computer-based open service 202;

an open service wrapper 315 that augments the open service element 312 as a result of cooperating with an interface that adheres to the structure of a programming paradigm 612, and the open service wrapper 315 maps information about the functionality of the open service 202 and about the management of the open service 202, such as starting and stopping an open service instance 328, from a structure that adheres to a programming paradigm 612;

an open service type repository 324 that associates open service descriptions 316 with installed open service types 314;

an open service description 316 that includes a description of the functionality of the open service 202 and the charging information 501 associated with the open service 202;

an open service functional description 318 that is included in the open service description 316 and that is a description of the functionality of the open service 202;

an open service management description 320 that is included in the open service description 316 and that is a description of management information such as charging information 501;

an open service type 314 that enables delivery of an open service instance 328;

an EVENT_{VERB} 504 that is a message 502 that is switched by the contract monitor 406 during the operation of the present embodiment;

an open service contract 326 that operates as a managed connection that links interactions 506 between open service instances 328 associated with the open service contract 326, and the open service contract 326 includes billing and payment policies 505;

an open service contract view handler 307 that is associated with an open service contract view 306;

a marketmaker 404 that creates an electronic environment of business trust to ensure a party may safely transact an open service 202;

a revenue meter 408 that resolves information required to create charging information 501 associated with an open service contract 326 that may be used for billing;

a contract monitor 406 that resolves information regarding policy requirements that are associated with managing the open service contract 326 and monitors communication associated with performance of an open service contract 326;

a flow 409 is a specification of the switching of messages 502;

an open service offer 332 that is an offer associated with the formation of an open service contract 326 and is negotiable, and the open service offer 332 includes pricing information 503;

an open service instance 328 that may be represented as a specific result of the execution of the open service type 303 executable file;

a chargeable transaction 510 that specifies charging information 501;

charging information 501 that is included in the open service description 316 and that defines the type of open services 202 that may be given for value and the type of charging mechanism that may be used;

pricing information 503 that is contained in the open service offer 332 and is associated with a particular open service instance 328;

a billing and payment policy 505 that associates specific pricing information 503 with an open service contract 326 (as shown in FIG. 2) via an open service contract view 306 and describes how billing and payment will occur, and may be referred to herein as a “billing policy;”

billing information 511 that may be delivered to a billing system;

an interaction 506 that is a protocol of messages 502 defined in a vocabulary 610 that has a precise meaning for at least one programming language paradigm 612;

a conversation 508 that is a session for service usage and an interaction 506 operates within a conversation 508;

a conversation handler 509 that is associated with a conversation 508;

a mediator 322 that enables the creation of an open service offer 308;

data 608 that is information used during the operation of the open service execution module 102;

a data_type 606 that identifies the nature of the data 608, such as integer or character and may be defined in a vocabulary 610;

a verb 602 that is associated with an event 502 and derives meaning by the operation of the event 502 by association with a set of rules that are defined in the vocabulary 610;

a label 604 that may identify that an event 502 is operating in a certain state;

a vocabulary 610 that includes a set of rules that are used during the operation of the open service execution module 102;

an open service lifecycle 204 that includes phases that are elements of the process of creating and managing an open service contract 326;

a value 230 that includes instructions 208 and data 608, such as integer, real, or complex numbers, characters, or pointers that reference values 230;

a module 227 that may refer to a software procedure or function such as a unit of code that may be independently compiled;

an instruction 208 that may represent a computer address 225 and that may also include variables that are identifiers for values 230;

an address 225 that may be a computer hardware register or a location in the memory 106 (as shown in FIG. 1A);

a compilation system 108 that translates program code into instructions 208 that operate on the computer system 100;

an emulator 190 that substitutes instructions 208 typically associated with a different computer system 100 than the executing computer system 100;

source code 160 that is manipulated by a computer system 100 and that is typically written in a high-level programming language such as “C;”

intermediate code 164 that is a list of intermediate-level language instructions 208;

object code 168 that includes optimization changes which may be dependent on the particular multi-purpose computer system 100 on which the compilation system 108 operates;

executable code 172 that is capable of executing on a multi-purpose computer system 100;

a programming language paradigm 612 that is typically embodied in a computer-based language that is used to code a computer system 100;

an IDL technology 614 that specifies computer-based interfaces, such as an API;

an object-based technology 616 that includes objects that receive and send messages 502;

a linguistic communication technology 618, such as agent code;

as well as other data structures 608 and modules 227.

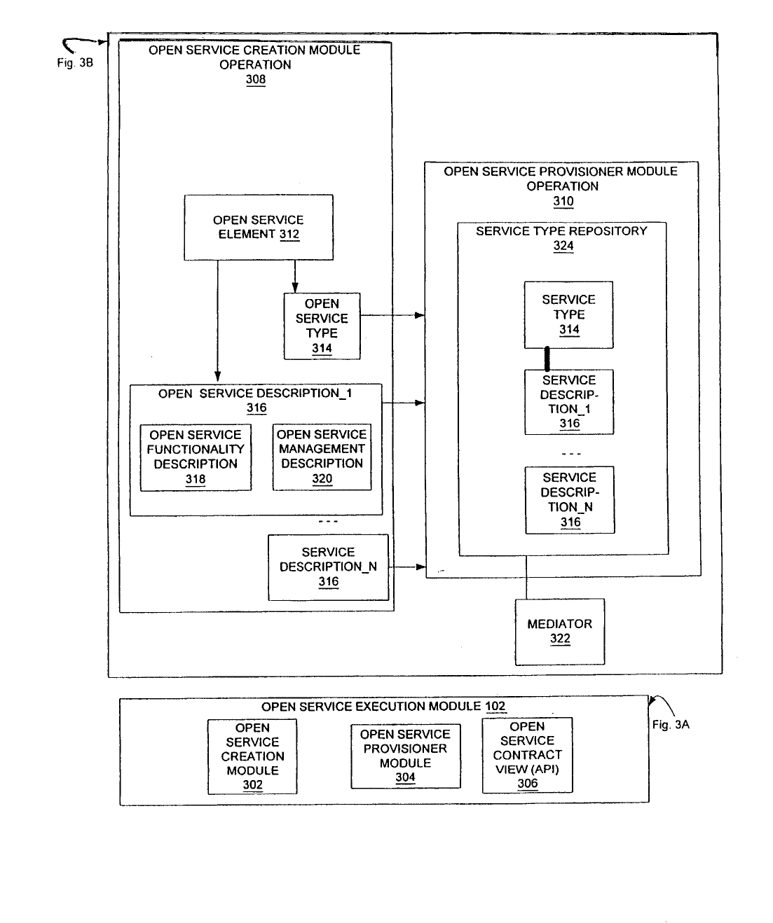

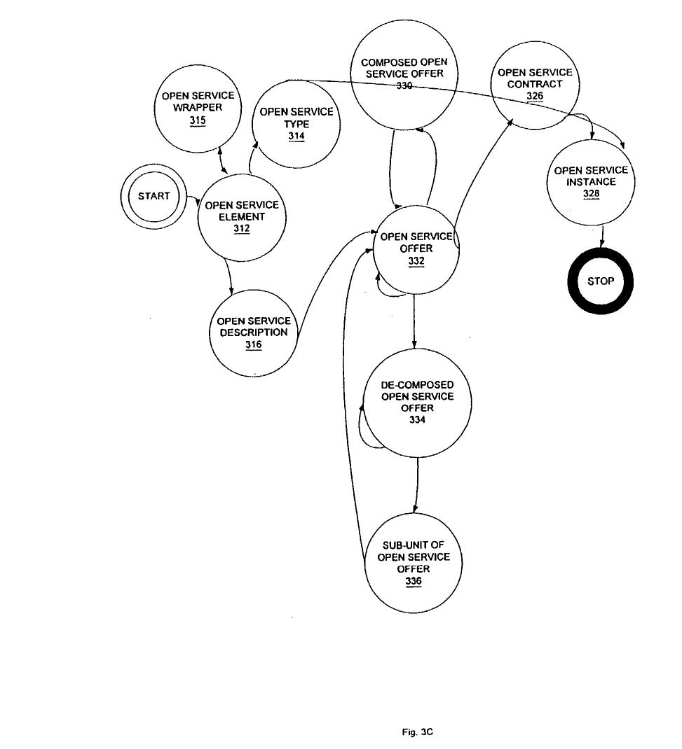

FIG. 3A is a block diagram that illustrates the open service execution module 102 that includes the open service creation module 302. The open service creation module 302 operates to create an open service description 316 and an open service type 314 by use of an open service element 312 (as are shown in FIG. 2). Recall that a user or other computer-based code may create an open service element 312 that includes computer-readable directives to provide a computer-based open service 202 (as shown in FIG. 2).

The open service execution module 102 also includes an open service provisioner module 304 that operates to associate at least one open service description 316 with an open service type 314. The open service provisioner module 304 enables the mediator 322 (as shown in FIG. 2) to access information about the open service description 316. The open service execution module 102 also includes the open service contract view 326 that enables conversion of a conversation 508, that is created by the execution of an open service instance 328, to a format that complies with an existing programming language paradigm 612 (as are shown in FIG. 2).

FIG. 3B is a flow diagram that illustrates the operation of the open service creation module as shown in element 308 and the operation of the open service provisioner module as shown in element 310. The open service creation module 302 converts an open service element 312 to an open service type 314. The open service creation module 302 uses the open service element 312 that may cooperate with an interface that adheres to the structure of a programming paradigm such as an IDL 614, a linguistic communication technology 618 such as agent code, or object-based technology 616 that typically includes methods that have names (as are shown in FIG. 2). Therefore the open service element 312 will be augmented with additional computer-based code, herein referred to as an open service wrapper 315, as a result of cooperating with an interface that adheres to the structure of a programming paradigm 612. The open service wrapper 315 also enables management during the open service lifecycle 204 (as shown in FIG. 2) by mapping management information from a structure that adheres to a programming paradigm 612. The open service creation module 302 uses both the open service element 312 and the open service wrapper 315 to create an open service type 314.

A computer-based wrapper is a code segment that enables implementation of code that complies with a software architecture to be converted to code that complies with a different software architecture. For example, a wrapper may enable migration of a pre-existing software code segment to operate with a different software architecture.

Further, the open service creation module 302 creates an open service description 316 that is associated with the open service element 312. An open service description 316 consists of both an open service functionality description 318 that describes the functionality associated with the generated open service type 314 and an open service management description 320 associated with the open service type 314, such as charging information 501 (as shown in FIG. 2). The open service execution module 102 (as shown in FIG. 2) novelly includes the open service functionality description 318 and the open service management description 320 in the open service description 316 thereby ensuring that the information is accessible and useful throughout the computer-based network 146 (as shown in FIG. 1A).

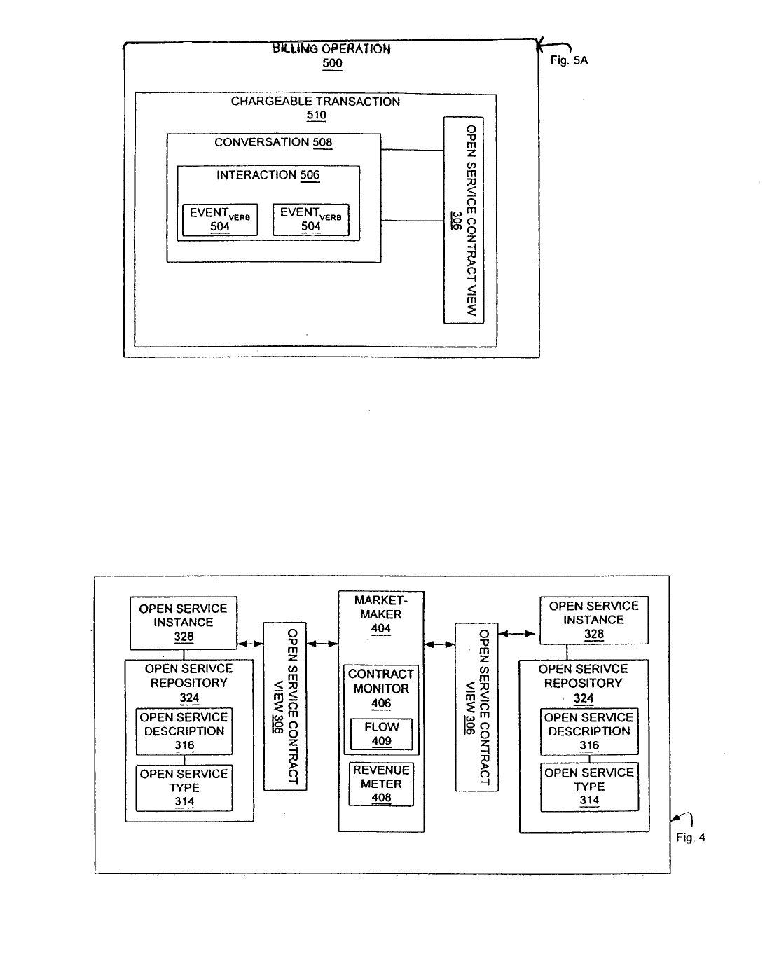

The open service provisioner module 304 installs the associated open service type 314 and the open service descriptions 316 in the open service type repository 324. Further, the open service provisioner module 304 may remove or associate other open service descriptions 316 with an open service type 314 as appropriate computer-based events 502 (as shown in FIG. 2) occur. The association of an open service type 314 with an open service description 316 may change over the lifecycle of the open service type 314 as the execution of open service instances 328 (as shown in FIG. 2) effect the open service contract 326 (as shown in FIG. 2) and its associated open service contract view 306. For example, since the present embodiment is a message-based solution messages may continue to impact the operation of the present embodiment. An open service type repository 324 may contain more than one open service description 316 that is associated with an open service type 314. As part of the operation of the open service provisioner module 304 the open service descriptions may be made available to a mediator 322. The open service contract 326 and the open service contract view 306 will be discussed with reference to FIG. 4.

FIG. 3C is a state diagram that illustrates the state of information and data 608 during the method of operation of the open service execution module 102 (as are shown in FIG. 2). The term “state” as used herein refers to a set of rules that determine the order of operation of segments of computer code that may execute on a computer system 100 (as shown in FIG. 1A).

The open service element 312 is a code segment that provides an open service 202 (as shown in FIG. 2). The open service element 312 is used to produce meta-data about the open service element 312 that is the open service description 316. The open service description 316 in turn is used to create an open service offer 332 that includes a description of the open service 202 and the pricing information 503 (as shown in FIG. 2) associated with the open service 202. The open service element 312 is augmented by the open service wrapper 315 that adheres to the structure of a programming paradigm 612 (as shown in FIG. 2). Also the open service element 312 is used to produce an open service type 314.

The open service offer 332 may be de-composed as shown in element 334 into sub-units of the open service offer as shown in element 336. The sub-units of the open service offer may also be presented as new open service offers 332. Similarly, the open service offer 332 may be combined with other open service offers 332 into a new open service offer as shown in element 330. The newly composed open service offer 332 may also be presented as an open service offer 332.

The open service offer 332 may be formed into an open service contract 326. An open service contract 326 in cooperation with an open service type 314 may be used to create an executable open service instance 328.

FIG. 4 is a block diagram that illustrates the operation of executing an open service instance 328 on a computer system 100 (as shown in FIG. 1A) during performance of an open service contract 326. The present embodiment converts an open service element 312 to an open service instance 328 (as are shown in FIG. 2) that may receive and transmit computer-based messages 502 (as shown in FIG. 2) with other open service instances 328. An open service instance 328 is executable code 172 (as shown in FIG. 2) that is associated with an open service type 314 and an open service description 316 (as are shown in FIG. 2). The open service instance 328 operates by transmitting a message, such as an event 502, that is converted by the open service contract view 306 that is an API.

More particularly the open service description 316 and the open service type 314 that includes code from an open service wrapper 315 enables execution of an open service instance 328. The marketmaker 404 may act as an intermediary to enable communication between open service instances 328. Further, an open service contract view 306, that may be implemented as an object, provides the interface necessary to convert the open service instance 328 and its associated code from an open service wrapper 315 to a form that may be used by the marketmaker 404.

The open service instance 328 may perform open services 202 that operate within an open services lifecycle 204 (as are shown in FIG. 2). An open service instance 328 is bound to an open service description 316 and an open service type 314. More particularly, an open service description 316 may contain a state diagram in the open service functional description 318 (as shown in FIG. 2) that includes information that enables communication of computer-based messages 502 between an open service contract view 306 associated with one open service instance 328 and another open service contract view 306 associated with another open service instance 328, via the intermediary of the marketmaker 404.

An open service contract 326 includes (as shown in FIG. 2) connection specification information, such as flows 409, for communication between open service instances 328 via open service contract views 306 and contains billing and payment policies 505 (as shown in FIG. 2) as well. The contract monitor 406 is included in the marketmaker 404 and manages the switching of messages 502 such as EVENT_{VERBS} 504 (as are shown in FIG. 2). When an EVENT_{VERB} 504 is recognized by the contract monitor 406 it is transmitted by the contract monitor 406 to the appropriate open service instances 328. Therefore, the contract monitor 406 manages the switching of EVENT_{VERBS} 504 that are associated with interactions 506 and conversations 508 (as are shown in FIG. 2) that include messages 502 that perform open service contracts 326.

The contract monitor 406 manages the switching of messages 502, according to defined flows 409, in the open service contract 326. Flows 409 define connection graphs that describe the operation of execution of code. An example of a flow 409 is a work flow or multi-cast. As is known in the art, connection graphs operate to manage the transmission of messages 502. Flow 409 may be described by techniques such as work flow process definition languages.

An open service instance 328 enables communications from interactions 506 and conversations 508 (as shown in FIG. 2). A conversation 508 is a state machine composed of interactions 506 and messages 502 and defines the appropriate order for operation of a series of interactions 506. Conversations 508 may include interactions 506 such as “open,” “close,” “move-to-entry,” “read,” and “write.” An interaction 506 may include a message 502 and may operate within a conversation 508. An interaction 506 is also a state machine and may define how messages 502 are transmitted and received. The open service functional description 318 contains a description of state machines as conversations 508.

Each open service contract view 306 may have more than one conversation 508 active at the same time thus creating a need to manage concurrency created by the simultaneous activity of conversations 508. The operation of the open service instance 328 may ultimately impose concurrency control on EVENT_{VERBS} 504.

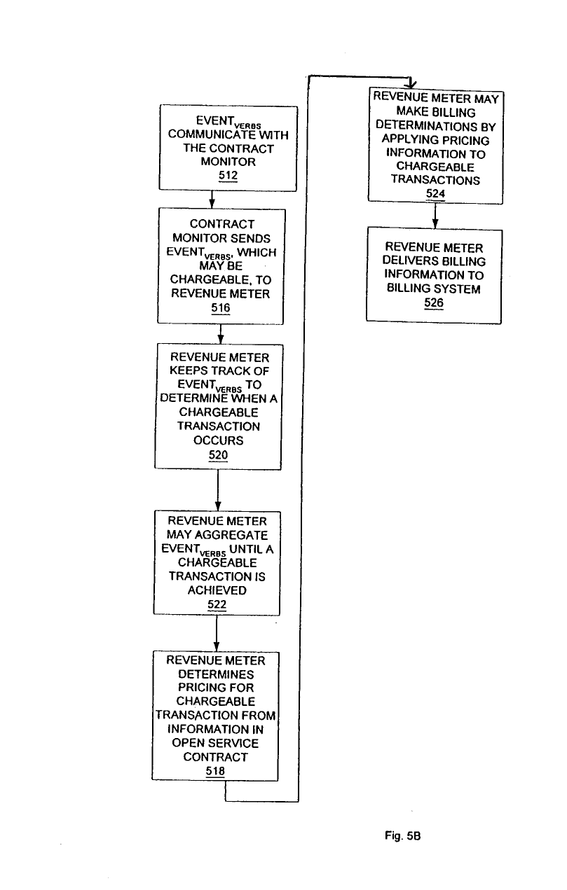

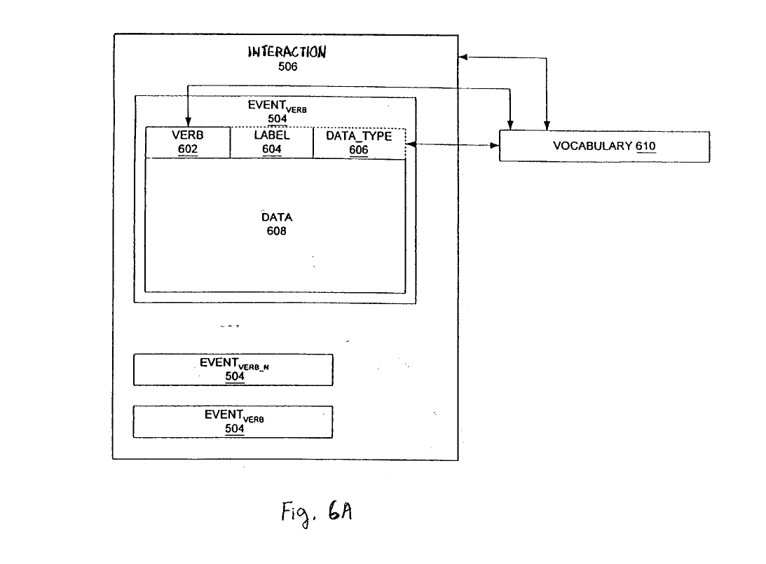

The revenue meter 408 is also included in the marketmaker 404. The revenue meter 408 receives EVENT_{VERBS} 504 from the contract monitor 406 and uses charging information 501, pricing information 503, and billing and payment policies 505 (as are shown in FIG. 2) that are associated with the open service contract 326 for billing purposes. The revenue meter 408 will be discussed with reference to FIG. 5B.

FIG. 5A is a block diagram that illustrates the billing operation as shown in element 500. Charging information 501 defines the type of open services 202 (as are shown in FIG. 2) that may be given for value and the type of charging mechanism that may be used, such as flat rate or pro-rata charging. Human interaction may be required to determine policies from which the charging information 501 may be derived. Pricing information 503 (as shown in FIG. 2) associates a particular rate with the charging information 501. A billing and payment policy 505 associates specific pricing information 503 with an open service contract 326 (as are shown in FIG. 2) via an open service contract view 306 and describes how and when billing and payment will occur. While the charging information 501 is included in the open service description 316 (as shown in FIG. 2), the actual pricing information 503 associated with a particular open service instance 328 is contained in the open service offer 332 (as shown in FIG. 2).

Charging information 501 is specified by use of chargeable transactions as shown in element 510. A chargeable transaction 510 includes a variety of operational levels such as the EVENT_{VERB} 504, the interaction 506, the conversation 508, and the open service contract view 306. Chargeable transactions 510 may be referred to either by the type of chargeable transaction 510 or by the label 604 (as shown in FIG. 2) of the chargeable transaction 510.

Chargeable transaction 510 information is obtained by the contract monitor 406 from the open service contract 326. The revenue meter also obtains chargeable transaction 510 information from the open service contract 326.

Charging information 501 may be categorized in the following ways. Objectively charging information 501 may be:

constant, in which the charging information 501 is dependent on the occurrence of each chargeable transaction 510;

spatial, in which the charging information 501 is dependent on the size of the data 608 in a chargeable transaction 510; or

time-based, in which the charging information 501 is dependent on the duration of a chargeable transaction 510.

Subjective charging information 501 may be:

value-based, in which the charging information 501 is dependent on information extracted from the data 608 associated with the chargeable transaction 510.

FIG. 5B is a block diagram that illustrates the process of billing EVENT_{VERBS} 504 by the marketmaker 404. The EVENT_{VERB} communicates with the contract monitor 406 as shown in element 512. The contract monitor 406 then sends the EVENT_{VERBS} 504 to the revenue meter 408 as shown in element 516. The EVENT_{VERBS} 504 sent by the contract monitor 406 may optionally be filtered so that only those chargeable EVENT_{VERBS} 504 are sent to the revenue meter 408. The contract monitor 406 also informs the revenue meter 408 of the start and end of conversations 508 and interactions 506, and of the end of an open service contract 326 thereby facilitating billing. The open service contract 326, the contract monitor 406, the revenue meter 408, the EVENT_{VERB} 504, the message 502, the marketmaker 404, conversations 508, and interactions 506 are shown in FIG. 2.

The revenue meter 408 keeps track of the EVENT_{VERBS} 504 to determine when a chargeable transaction 510 occurs as shown in element 520. The revenue meter 408 may aggregate EVENT_{VERBS} 504 until a chargeable transaction 503 is achieved as shown in element 522. The chargeable transaction 510, and the pricing information 503 are shown in FIG. 2.

The revenue meter 408 determines the pricing for chargeable transactions 510 from pricing information 503 in the open service contract 326 as shown in element 518. The revenue meter 408 may make billing determinations by applying pricing information 503 to the chargeable transaction 510 as shown in element 524. Also, the revenue meter 408 may deliver billing information 511 to an optional billing system as shown in element 526. Computer-based billing systems may operate to create billing records that may be used to transact business.

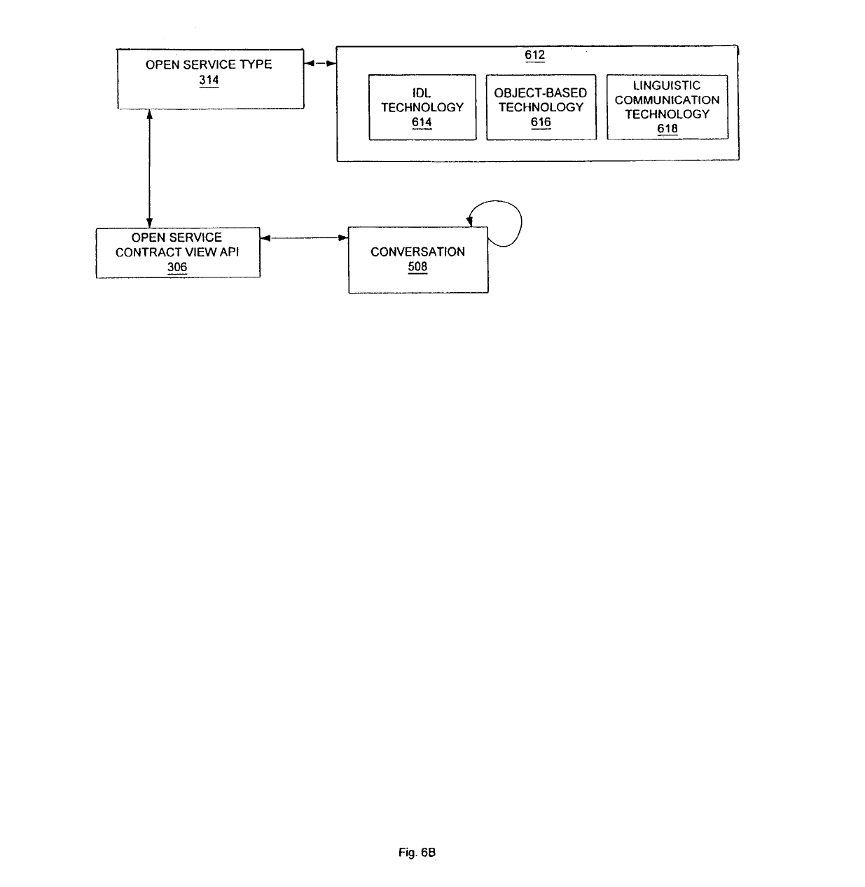

FIG. 6A is a block diagram that illustrates the elements of an interaction 506. Interactions 506 may include a protocol that associates information with a message, such as an event 502 (as shown in FIG. 2), that is transmitted in a computer-based network 146 (as shown in FIG. 1A). The term “protocol” as used herein represents the rules determining the formatting and transmission of data 608. Interactions 506 describe protocols of EVENTVER_{VERBS} 504. Interactions 506 may terminate successfully or unsuccessfully thereby operating as a null protocol. However, generally interactions 506 are composed of EVENT_{VERBS} 504 that are adapted to comply to the rules associated with the verb 602.

The verb 602 may be associated with a vocabulary 610 that defines the operation that occurs with respect to the verb 602. More particularly the verb 602 that is associated with the EVENT_{VERB} 504 derives meaning by the operation of the EVENT_{VERB} 504 by association with a set of rules that are defined in the vocabulary 610.

Further, interactions 506 are protocols of messages 502 defined in vocabularies 610 that have precise meanings for at least one programming language paradigm 612 (as shown in FIG. 2).

Under some circumstances, a conversation 508 (as shown in FIG. 2) may be included in a vocabulary 610. For instance, when a conversation 508 is documented, it may be included in a vocabulary 610.

By means of example an interaction 506 may be associated with a remote procedure call (RPC) programming paradigm 612 (as shown in FIG. 2). RPC paradigms tend to use request-response interactions 506. Examples of RPC calls include getting a file, looking up a file name, and reading and writing from a file.

The term “vocabulary” as used herein is the definition of a term that adds meaning to the term and also describes a protocol that is used to implement a computer-based communication solution associated with the term. Vocabularies 610 are intended to be pervasive and domain-specific.

This use of a vocabulary 610 novelly enables the open service execution module 102 to operate without reliance on a client-server computing environment. By means of comparison a distributed computing solution may include methods and objects which are not well grounded in semantics due to the design reliance on predictable behavior of messages 502 from a server and predictable behavior of messages 502 from a client.

The present embodiment novelly uses vocabularies 610 that are distributed among the participants in an electronic business transaction. The vocabulary 610 is accessible throughout the electronic commerce system. The participants may be operating on different computer systems 100 (as shown in FIG. 1A) across a distributed computer environment, such as the internet. The vocabulary 610 describes the meaning associated with a verb 602, an interaction 506, a data_type 606, and optionally a conversation 508.

The EVENT_{VERB} 504 also may include an optional label 604 that identifies a state associated with either an interaction 506 or a conversation 508 thereby efficiently enabling charging information 501 (as shown in FIG. 2) to be expressed. If an interaction 506 or conversation 508 is labeled then all of the EVENT_{VERBS} 504 included in the interaction 506 or conversation 508 are similarly labeled.

The EVENT_{VERB} 504 also includes data 608 and may optionally include a data_type 606 that enables efficient operation of the interaction 506. The data_type 606 identifies the nature of the data 608, such as integer or character. Data types 606 may be defined in a vocabulary 610.

By means of example, if a verb 602 represents “PERFORM” and a label 604 represents “BUY” then the data 608 included in the interaction 506 will provide the remaining information to enable an open service 202 (as shown in FIG. 2) to be performed. The data_type 606 in this example may include [PRODUCT_NUMBER and PRICE]. Therefore if the PRICE=$100 is included in the data 608 the operation expresses buying a product for the price of $100.

FIG. 6B is a block diagram that shows the operation of a conversation 508 and a programming language paradigm 612. A conversation 508 defines a high level protocol for performing an open service contract 326 (as shown in FIG. 2). The conversation 508 is converted by the open service contract view 306 in association with the open service 314 type to a format that complies with an existing programming language paradigm 612. Thereby the present embodiment enables computer-based code that is created in existing programming language paradigms 612 to be used by the open service execution module 102 (as shown in FIG. 2). A conversation 508 may terminate or may operate in a recursive fashion.

By means of example, software programming paradigms 612 include IDL's 614 that specify computer-based interfaces, such as API's. Therefore, the source code 160 (as shown in FIG. 2) may be developed to comply with an IDL 614 and then is translated to a form of source code 160 that operates with the compilation system 108 (as shown in FIG. 1A). CORBA and RMI are examples on an IDL 614.

A problem with IDL-based software is that IDL's 614 typically describe a fixed communication interaction model. For example, IDL's 614 do not define operations that work by asynchronous event delivery. IDL's 614 are generally used to describe interactions 506 that occur in a client-server environment. In a client-server environment one computer system 100 (as shown in FIG. 1A) typically initiates messages 502 (as shown in FIG. 2) and the other computer system 100 typically responds to the messages 502. An IDL 614 does not facilitate detailed descriptions of an open service 202 (as shown in FIG. 2) that require flexible roles during an electronic business transaction. The present embodiment novelly operates with interfaces that are bidirectional by nature since the present embodiment includes open service descriptions 316 and open service types 314 that enable the open service instance 328 (as are shown in FIG. 2) to operate without regard to whether a computer system 100 is a client or a server.

Another software programming paradigm 612 is the object-based software component technology 616 such as the product marketed under the trademark JAVA™ classes or Java™ Beans that allow introspection and dynamic method invocation. An object oriented software technology 616 includes objects that receive and send messages 502. Typically the object includes software code and data 608 (as shown in FIG. 2). An object is defined by a class that characterizes the attributes of the object. Therefore, an object is an individual instance of a class. A method is the action that a message 502 carries out. That is, it is the code that is executed when a message 502 is sent to an object.

Yet another programming language paradigm 612 is the linguistic communication technology 618 such as agent technologies. Software agents are dynamic and have control over their actions and state, are able to interact with other agents through a programming language, perceive their environment, respond to changes in their environment, and also are able to initiate actions. An agent communicates with other agents in a peer-to-peer format.

The present embodiment, including the open service contract view 306 enables interpretation of a number of programming language paradigms 612 and therefore introduces flexibility into electronic commerce for an open service 202. Therefore, the present embodiment supports the operation of an open service conversation 508.

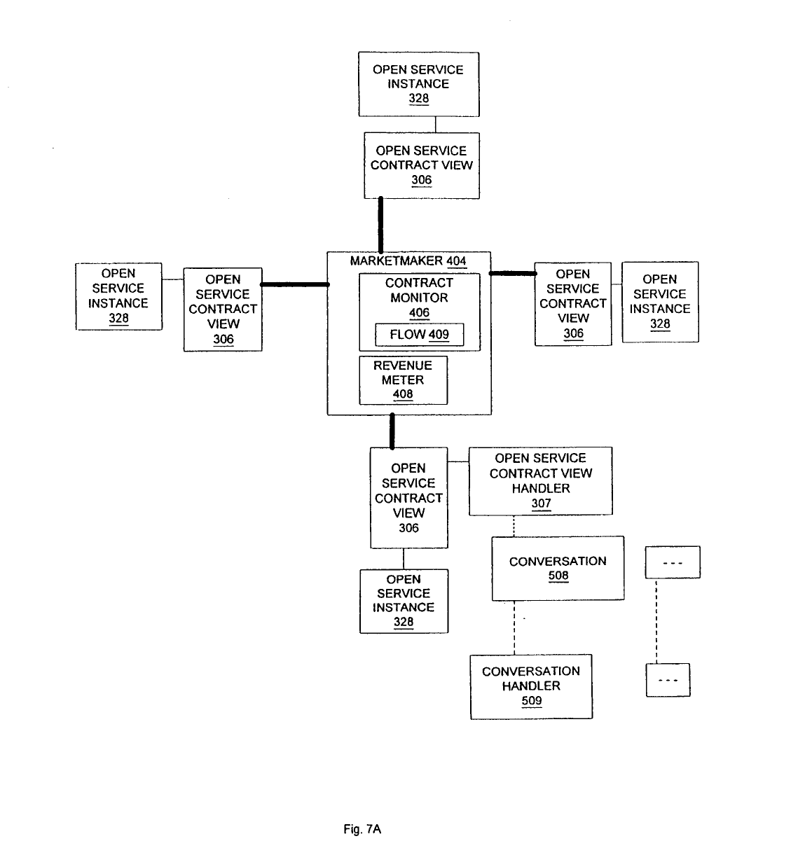

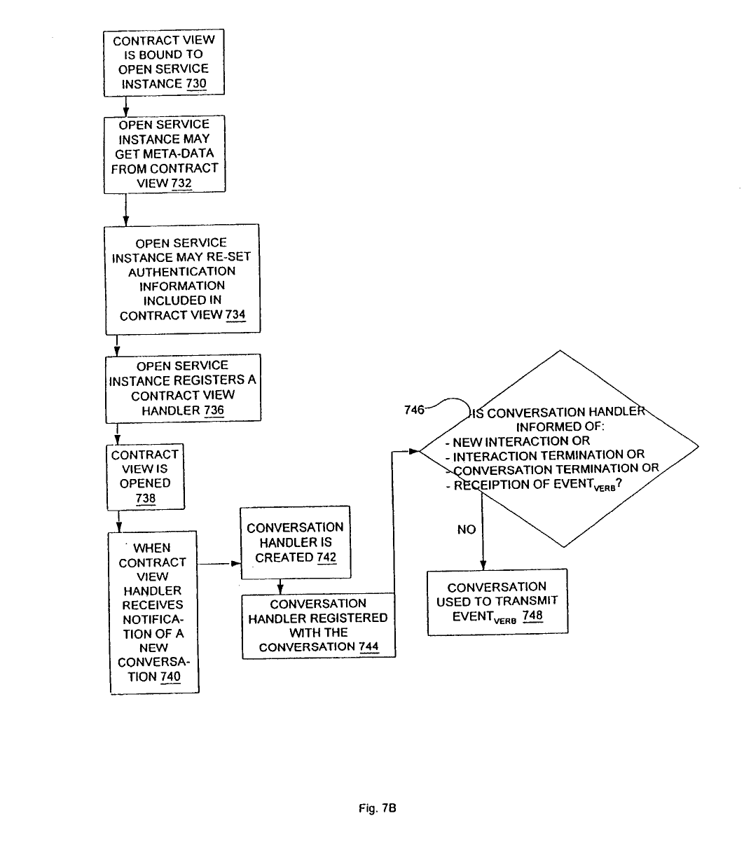

FIG. 7A is a flow diagram that illustrates the transmission of information associated with executing open service instances 328. The open service instances 328 may either operate passively by responding to messages 502 (as shown in FIG. 2) or may actively initiate new flows 409. Recall that a flow 409 is a specification of the switching of messages 502. The marketmaker 404 includes a revenue meter 408 and a contract monitor 406 that manage the transmission of messages 502, such as EVENT_{VERBS} 504 (as shown in FIG. 2). The contract monitor 406 behaves as a switch by managing information within flows 409.

Each open service instance 328 can participate by using an open service contract view 306 to initiate a new flow 409. When a new conversation 508 is initiated as a result of a new flow 409 a conversation handler 509 is created and is associated with the new conversation 508. A conversation 508 associated with an open service instance 328 may be used to send EVENT_{VERBS} 504 that are directed at specific open service instances 328 that are also associated with conversations 508 via flows 409. More particularly, an open service instance 328 may call an operation on a conversation 508, that may be implemented as an object, to send an EVENT_{VERB} 504 to another open service instance 328. The new EVENT_{VERB} 504 is appropriately switched by the contract monitor 406.

During passive operation an open service instance 328 may receive an EVENT_{VERB} 504 via an open service contract view handler 307 that represents notification of a new conversation 508. A conversation handler 509 is registered to the conversation 508 which in itself was initiated as a response to a new flow 409. Therefore an open service instance 328 may be associated with more than one conversation handler 509. The contract view handler 307 contains information regarding all of the newly created conversations 508 and will inform an open service instance 328 of new conversations 508.

FIG. 7B is a flow diagram that is a detailed illustration of the operation of forming and performing an open service contract 326 (as shown in FIG. 2). The contract view manager 406 creates an open service contract view 306 (as are shown in FIG. 2) when information is transmitted over a computer network 146 (as shown in FIG. 1A) by the marketmaker 404 (as shown in FIG. 2).

An open service contract view 306 is bound with an open service instance 328 (as shown in FIG. 2) as shown in element 730. Therefore an open service contract view 306 is usually associated with an open service instance 328 during the execution of an open service instance 328. When an open service instance 328 is implemented in an object oriented programming technology 616 (as shown in FIG. 2) the open service instance 238 obtains an open service contract view object.

As shown in element 732, the open service contract view 306 may have access to meta-data that is included in the open service description 318 of conversations 508 and flows 409 (as are shown in FIG. 2). The present embodiment novelly enables alteration of the open service instance 328 as a result of the information in the meta data.

The open service instance 328 may alter authentication information included in the open service contract view 306 as shown in element 734. For example, default authentication information associated with the open service contract view 306 may be changed to reflect new information about the participants to the open service contract 326.

The open service instance 328 registers an open service contract view handler 307 (as shown in FIG. 2) on the open service contract view 306 as shown in element 736. This may operate to enable messages 502 (as shown in FIG. 2) to be transmitted to the open service contract view 306 that may alter the performance of the open service instance 328 associated with the open service contract view 306.

Recall that the operation of the present embodiment enables peer-to-peer multi-party computer-based communication. Since the computer-based communication is not client-server based, each participant to the open service contract 326 must be logged into the computer system 100 (as shown in FIG. 1A) for the purpose of engaging in computer-based communication with respect to the open service contract 326. Therefore as shown in element 738, an operating session of the open service contract view 306 may be opened using the authentication information previously provided to the open service contract view 306 to enable secure communication. The open service instance 328 is effectively logged into the computer system 100 and capable of sending messages 502 over the computer network 146.

The open service contract view handler 307 then receives a message 502 indicating that the open service contract view 306 has been authenticated with respect to the open service instance 328 as shown in element 740. When a new conversation 508 is created as the result of a new flow 409 as shown in element 742, then the conversation handler 509 is registered with the conversation 508 as shown in element 744.

If the conversation handler 509 is not informed of a new interaction 506 (as shown in FIG. 2), or the termination of an interaction 506 or the termination of a conversation 508 occurs, or a reception of an EVENT_{VERB} 504 as shown in the test of element 746, then the conversation 508 is used to transmit an EVENT_{VERB} 504 as shown in element 748.

The foregoing description, for purposes of explanation, used specific nomenclature to provide a thorough understanding of the invention. However, it will be apparent to one skilled in the art that the specific details are not required in order to practice the invention. In other instances, well known devices are shown in block diagram form in order to avoid unnecessary distraction from the underlying invention. The flow charts of the present embodiment show the architecture, functionality, and operation of an implementation of the present embodiment. In this regard, each block represents a module, segment, or portion of code, which comprises one or more executable instructions for implementing the specified logical function(s). It should also be noted that in some alternative implementations, the functions noted in the blocks may occur out of the order noted in the figures, or for example, may in fact be executed substantially concurrently or in the reverse order, depending upon the functionality involved.

Thus, the foregoing descriptions of specific embodiments of the open service execution module are presented for purposes of illustration and description. They are not intended to be exhaustive or to limit the invention to the precise forms disclosed, many modifications and variations are possible in view of the above teachings. Those skilled in the art will recognize that changes may be made in form and detail without departing from the scope of the invention. The invention is limited only by the claims.

What is claimed is:

1. A method in a computer system for performing an open service on said computer system, said computer system having an open service element that includes computer-based directives that provide said open service, said method comprising:
creating an open service description and an open service type from said open service element;
associating at least one said open service description with said open service type;
associating an open service contract with said open service description;
creating an open service instance by said open service type and said open service contract;
associating an open service contract view with said open service contract thereby mapping said open service description and said open service type to said open service instance thereby enabling execution of said open service instance; and
executing said open service instance on said computer system thereby performing said open service.

2. The method as set forth in claim 1 further comprising:
creating an open service offer that is associated with said open service description; and
including pricing information associated with said open service in said open service offer thereby enabling billing of said open service.

3. The method as set forth in claim 2 further comprising:
including charging information in said open service description;
including a billing and payment policy in said open service contract;
associating said charging information and said pricing information; and
operating on said associated charging information and said associated pricing information to create billing information for said open service that complies with said billing and payment policy.

4. A computer system for performing an open service on said computer system, said computer system having an open service element that includes computer-based directives that provide said open service, said computer system comprising:
an open service description being created from said open service element;
an open service type being created from said open service element and said open service type being associated with at least one said open service description;
an open service contract being associated with said open service description;
an open service instance being created by said open service type and said open service contract;
an open service contract view associated with said open service contract that maps said open service description and said open service type to said open service instance thereby enabling execution of said open service instance; and
said open service instance executing on said computer system thereby performing said open service.

5. The computer system as set forth in claim 4 further comprising: an open service offer associated with said open service description and having pricing information associated with said open service thereby enabling billing of said open service.

6. The computer system as set forth in claim 5 further comprising:
said open service description having charging information said open service contract having a billing and payment policy;
said charging information being associated with said pricing information; and
billing information for said open service being created from said associated charging information and said associated pricing information and in compliance with said billing and payment policy.

7. A computer-readable medium containing instructions for causing a computer system to perform method acts to perform an open service on said computer system, said computer system having an open service element that includes computer-based directives that provide said open service, said method acts comprising:
creating an open service description and an open service type from said open service element;
associating at least one said open service description with said open service type;
associating an open service contract with said open service description;
creating an open service instance by said open service type and said open service contract;
associating an open service contract view with said open service contract thereby mapping said open service description and said open service type to said open service instance thereby enabling execution of said open service instance; and
executing said open service instance on said computer system thereby performing said open service.

8. The computer-readable medium as set forth in claim 7, said method acts further comprising:
creating an open service offer that is associated with said open service description; and
including pricing information associated with said open service in said open service offer thereby enabling billing of said open service.

9. The computer-readable medium as set forth in claim 8, said method acts further comprising:
including charging information in said open service description;
including a billing and payment policy in said open service contract;
associating said charging information and said pricing information; and
operating on said associated charging information and said associated pricing information to create billing information for said open service that complies with said billing and payment policy.

10. A method in a computer system for communicating an EVENT_{VERB} between a first open service instance and a second open service instance, said method comprising:
transmitting said EVENT_{VERB} in said computer system by said first open service instance;
defining a flow thereby enabling switching of said EVENT_{VERB} to said second open service instance; and
switching said EVENT_{VERB} to said second open service instance thereby communicating said EVENT_{VERB} between said first open service instance and said second open service instance.

11. The method as set forth in claim 10 further comprising:
associating an open service with communication between said first open service instance and said second open service instance;
identifying a chargeable transaction thereby enabling billing for said open service; and
determining pricing information associated with said chargeable transaction thereby creating billing information for said open service.

12. The method as set forth in claim 11 further comprising: delivering said billing information to a billing system.

13. A computer-readable memory device encoded with a data structure having entries for creating an interaction entry and a source program entry that executes on said computer, said memory device comprising:
a vocabulary entry that defines a protocol of operation of said interaction entry;
a verb entry that is associated with said vocabulary entry;
an EVENT_{VERB} entry that is adapted to comply with said protocol associated with said verb entry and that includes data thereby enabling execution of said interaction entry; and
said source program entry executing said interaction entry.

14. The computer-readable memory device as set forth in claim 13, further comprising: said interaction entry being described by a programming paradigm thereby said source program entry executing said interaction adheres to said programming paradigm.

15. The computer-readable memory device as set forth in claim 13, further comprising: a label entry included in said EVENT_{VERB} identifying said EVENT_{VERB} operating in a certain state thereby enabling efficient charging of said interaction entry.

16. The computer-readable memory device as set forth in claim 13, further comprising: a data_type entry included in said EVENT_{VERB} entry identifying said data thereby enabling efficient execution of said interaction entry.

17. A computer-readable memory device encoded with a data structure having entries for creating an open service instance entry that is included in a source program entry that executes on said computer, said computer having a programming paradigm, said memory device comprising:
an open service element entry that provides an open service entry;
an open service description entry produced from said open service element entry;
an open service offer entry created by said open service description entry that includes said open service description entry and a pricing information entry;
an open service wrapper entry that augments said open service element entry and that adheres said programming paradigm;
an open service type entry produced from said open service element entry;
an open service contract entry being formed from said open service offer entry by cooperation with said open service type entry; and
said open service contract entry creating said open service instance entry that is included in said source program entry that executes on said computer.

18. A method in a computer system for communicating an EVENT_{VERB} on said computer system, said computer system having an open service contract, said method comprising:
creating an open service contract view from said open service contract when said EVENT_{VERB} is communicated in said computer system;
binding said open service contract view with an open service instance;
registering an open service contract view handler on said open service contract view thereby enabling said EVENT_{VERB} to be transmitted to said open service contract view; and
receiving said open service contract view by said open service instance thereby communicating said EVENT_{VERB}.

19. The method as set forth in claim 18, further comprising: authenticating said open service contract view in said computer system thereby securing communication on said computer system.

20. The method as set forth in claim 19, further comprising: altering said open service contract view to change authentication.

21. A computer-readable medium containing instructions for causing a computer system to perform method acts to communicate an EVENT_{VERB} on said computer system, said computer system having an open service contract, said method acts comprising:
creating an open service contract view from said open service contract when said EVENT_{VERB} is communicated in said computer system;
binding said open service contract view with an open service instance;
registering an open service contract view handler on said open service contract view thereby enabling said EVENT_{VERB} to be transmitted to said open service contract view;
receiving said open service contract view by said open service instance thereby communicating said EVENT_{VERB}.

22. The computer-readable medium as set forth in claim 21, said method acts further comprising: authenticating said open service contract view in said computer system thereby securing communication on said computer system.

23. The computer-readable medium as set forth in claim 22, said method acts further comprising: altering said open service contract view to change authentication.
